(19) United States
(12) Patent Application Publication
(10) Pub. No.: US 2022/0069286 A1
(43) Pub. Date: Mar. 3, 2022

(54) POLYMER EMBEDDED ELECTRODES FOR BATTERIES

(71) Applicant: URBAN ELECTRIC POWER INC., Pearl River, NY (US)

(72) Inventors: Jinchao HUANG, Pearl River, NY (US); Sanjoy BANERJEE, Pearl River, NY (US); Alexander COUZIS, Pearl River, NY (US); Andrew NAUKAM, Pearl River, NY (US); Michael NYCE, Pearl River, NY (US)

(21) Appl. No.: 17/420,959

(22) PCT Filed: Jan. 7, 2020
(86) PCT No.: PCT/US2020/012584

§ 371 Date: Jul. 6, 2021

Related U.S. Application Data
(60) Provisional application No. 62/789,084, filed on Jan. 7, 2019.

(51) Int. Cl. H01M 4/137

(52) U.S. Cl. CPC H01M 4/137; H01M 4/661

(57) ABSTRACT

An electrode includes an electrode material, a polymer substrate, and a current collector. The electrode material comprises an electroactive material, and the electrode material forms an electrode material sheet. The electrode material sheet is disposed on the polymer substrate, and a current collector in electrical contact with the electrode material.

### CROSS-REFERENCE TO RELATED APPLICATIONS

This application claims the benefit of U.S. Provisional Application No. 62/789,084 filed on Jan. 7, 2019 and entitled “Fabrication of a Polymer Embedded Electrode and its Application in Batteries,” which is incorporated herein by reference in its entirety for all purposes.

### STATEMENT REGARDING GOVERNMENTALLY SPONSORED RESEARCH OR DEVELOPMENT

Not applicable.

### BACKGROUND

Alkaline cells have been predominantly used as primary batteries. However, the one-time use of primary batteries results in large material wastage as well as undesirable environmental consequences. Also, potential economic losses can arise due to the significant imbalance between the energy that is required to manufacture these cells compared to the energy that can be actually stored. As a consequence, there is a clear advantage to provide rechargeable or secondary cells.

### SUMMARY

In some embodiments, a battery includes an anode, a cathode, a separator disposed between the anode and the cathode, and an electrolyte in electrical communication with the anode, the cathode, and the separator. At least one of the anode or the cathode comprises an electroactive material disposed on a polymer substrate. The polymer substrate can be a porous or non-porous sheet.

In some embodiments, an electrode layer comprises an electrode material, a polymer substrate, and a current collector. The electrode material comprises an electroactive material, and the electrode material forms an electrode material sheet. The electrode material sheet is disposed on the polymer substrate, and a current collector in electrical contact with the electrode material.

In some embodiments, a method of operating a battery comprises discharging a battery, where the battery comprises a housing, an anode, a cathode, a separator disposed between the anode and the cathode within the housing, and an electrolyte in fluid communication with the anode, the cathode, and the separator. At least one of the anode or the cathode comprises an electroactive material disposed on a polymer substrate.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic cross sectional view of the electrode configuration according to an embodiment.

FIG. 2A is a schematic cross sectional view of the electrode configuration according to an embodiment.

FIG. 2B is a plan view of the electrode of FIG. 2A.

FIG. 3A is an exploded view of an electrode according to an embodiment.

FIG. 3B is a schematic cross sectional view of the electrode configuration of FIG. 3A.

FIG. 3C is a plan view of the electrode of FIG. 3A.

FIG. 4 is a schematic cross-sectional view of a battery according to an embodiment.

FIG. 5 is a perspective view of a battery having a rolled configuration according to an embodiment.

FIG. 6 is a graph illustrating the capacity curves vs. cycle number for a prismatic cell with an EMD/PP mesh electrode with two Ni tabs as the current collector according to Example 1.

FIG. 7 is a graph illustrating the capacity curves vs. cycle number for a prismatic cell containing an EMD/PP mesh electrode with a Ni tab/Ni mesh current collector according to Example 2.

### DETAILED DESCRIPTION

In this disclosure, the terms “negative electrode” and “anode” are both used to mean “negative electrode.” Likewise, the terms “positive electrode” and “cathode” are both used to mean “positive electrode.” Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

Disclosed herein are polymer mesh embedded electrodes for use in primary and secondary batteries. Batteries containing such electrodes in either prismatic or jelly roll form are designed and tested.

In some embodiments, a method for preparing an electrode can include selecting a polymer material for use as the coating substrate for electrodes. The polymer materials include but are not limited to polyamides, polycarbonate, polyester, polyethylene, polypropylene (PP), polystyrene, polyvinyl chloride, acrylonitrile butadiene styrene, polytetrafluoroethylene, polyimide, polyetheretherketone polysulfone, polyaniline, polypyrrole, or poly(3,4-ethylenedioxythiophene). The polymer materials can be used alone or as a blend of any combinations thereof. The structures of the polymer substrate can include a polymer mesh, a polymer sheet, a polymer foam, a perforated sheet, or any combination thereof.

Methods for fabricating polymer embedded electrodes are also disclosed. The methods for integrating the polymer substrate into the electrode include but are not limited to coating, printing, pressing, or any combinations thereof. The polymer substrate can be applied alone or applied together with metal current collectors.

In some embodiments, a method is disclosed for making a battery comprising a cathode, an anode, and a separator disposed between the anode and the cathode. At least one of the electrodes has polymer substrate embedded in it. The battery can be prismatic or cylindrical. The battery can be primary or secondary.

Disclosed herein are methods of using polymer mesh for electrode fabrication for use in batteries, for example, in primary and secondary alkaline zinc manganese dioxide batteries. The alkaline zinc manganese dioxide (Zn/MnO₂) battery has dominated the primary battery market since its creation. Currently, the rechargeable version of this chemistry is becoming attractive for large-scale energy storage applications because of the low cost and good safety characteristics of the basis material, as well as its high theoretical energy density. There is a great interest in reducing the cost, improving the manufacturability and improving the performance of Zn/MnO₂ batteries.

Roll-to-roll processing is a common process of creating electrodes for cells in prismatic or jelly roll form. Roll-to-roll processing refers to a process of applying one or more coatings of an electroactive material (e.g., the component(s) responsible for the electrochemical reactions to store energy within the battery) to a roll of flexible substrate material, to create an output roll. The flexible material for electrode fabrication is usually a layer of expanded metal mesh or metal foil, which serves as a substrate for coating as well as a current collector. In a conventional alkaline Zn/MnO₂ battery, one of the common substrate materials used for the cathode is a nickel (Ni) mesh or a nickel foil. And one of the common materials used for the anode is a copper (Cu) mesh or a copper foil. However, both nickel and copper are high-cost materials. These inactive components generally represent a significant portion of material cost associated with battery cell construction. To successfully reduce the cell cost while maintaining its performance, it is necessary to integrate lower-cost substrate materials for roll-to-roll coating that maintain or enhance cell performance. Therefore, polymer materials, which are highly cost-effective, are considered as alternative materials herein. A polymer substrate is also easier to transport, lightweight, and offers configuration and coating flexibility due to its strong yet pliable nature. It may be used as a full substitute for the copper or nickel substrate or used in conjunction with these materials. Even when current collector materials are used, the use of the polymer substrate can allow a smaller amount of the current collector material to be used in the battery construction.

The work described herein mainly relates to the preparation of polymer mesh embedded electrodes for use in primary and secondary batteries. The polymer mesh is used as a substitute for metal mesh or metal foil, which mainly works as a substrate for better manufacturability during electrode fabrication process and current collector. A lower cell cost is achievable with such electrode design while maintaining the manufacturability and cell performance. The resulting electrodes can be used in both primary and secondary zinc anode battery cells. The cell can be prismatic or cylindrical.

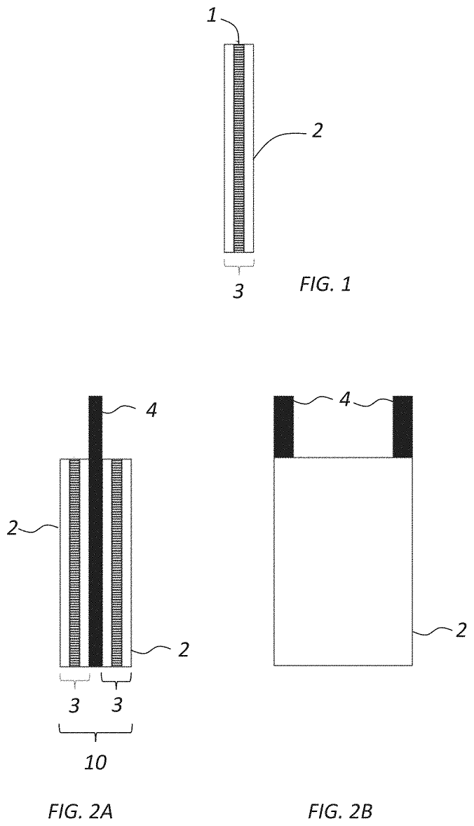

As shown in FIG. 1, an electrode layer 3 can be formed from one or more layers of an electrode material 2 disposed on or coupled to a polymer substrate 1. The electrode material 2 is described in more detail herein. The resulting electrode layer 3 can be used by itself and/or with a current collector to form an electrode.

The polymer substrate 1 can comprise a polymer and/or a polymer with a conductive (e.g., metallic, etc.) coating layer. The polymer materials used to form the polymer substrate 1 can include any suitable polymer that is stable in the electrolyte used in the battery. Suitable polymer can include, but are not limited to, polyamides, polycarbonate, polyester, polyethylene, polypropylene, polystyrene, polyvinyl chloride, acrylonitrile butadiene styrene, polytetrafluoroethylene, polyimide, polyetheretherketone, polysulfone, polyaniline, polypyrrole, poly(3,4-ethylenedioxythiophene), or any combination thereof. The polymer materials can be used alone, as a combination of individual materials (e.g., as mixed strands, etc.), and/or as a blend of any combinations thereof.

In some embodiments, the polymer substrate 1 can have a coating layer thereon in order to improve the conductivity within the electrode. The coating material can comprise any conductive material that can be coated on the underlying polymer material. In some embodiments, the materials of the coating layer can include, but are not limited to, a pure element, metallic alloy, oxide, or hydroxide of: bismuth, indium, calcium, barium, magnesium, silver, lead, cadmium, tin, titanium, iron, aluminum, nickel, copper, gold, platinum, or any combinations thereof. The coating layer can be applied by methods including, but not limited to, electrodeposition, electroless plating, and/or thermal spraying. The metallic coating layer can be applied to improve the electrode conductivity and/or to suppress gassing.

The polymer substrate 1 can be constructed into different structures, including but are not limited to mesh, foam, sheet, perforated sheet, or any combinations thereof. The thickness of the polymer substrate can vary from as thin as 10 μm to as thick as 5 mm. The porosity of the polymer substrate can vary from 0 to 90%. The hole diameter of the polymer sheet can vary from 0 to 1 cm.

The methods for integrating the polymer substrate into the electrode include but are not limited to coating, printing, pressing, welding, thermal spraying, or any combinations thereof. The method of forming the electrode layer 3 can be based on the form of the electrode material 2. In some embodiments, the electrode material 2 can be pressed onto the polymer substrate 1 to form the electrode layer. For example, the electrode material 2 can be adhered to the polymer substrate 1 by pressing at, for example, a pressure between 1,000 psi and 20,000 psi (between 6.9×106 and 1.4×108 Pascals). The electrode material 2 may be adhered to the polymer substrate 1 as a paste. In some embodiments, the same process can be applied to adhere the electrode layer 3 to the current collector.

In addition, the electrode layers and/or the electrode (e.g., electrode 10 of FIG. 2A) can be formed using a roll-to-roll process. In this process, the components forming the electrode material 2 can be combined in a vessel and mixed before passing to a continuous paste coater. In the paste coater, the polymer substrate 1 can be passed through the electrode mixture 2 to coat the polymer substrate 1 with the mixture of the electrode material 2 in a paste form. The electrode material 2 on the polymer substrate 1 can pass out of the coating and be dried in a drying oven before passing the resulting electrode layer 3 through a calendar press to provide a consistent thickness of the electrode layer 3. The resulting electrode layer 3 can then be stored for use with a cathode or anode. Since the resulting electrode layer 3 can be in the form of a roll, the overall process can be referred to in some contexts as a roll-to-roll process. The electrode layers can then be further combined with one or more additional electrode layers and the optional current collector in a roll configuration to form an anode or cathode.

The polymer substrate can be applied by itself or applied together with one or more metal current collectors to improve electrode conductivity. As shown in FIGS. 2A and 2B, the electrode material 2 with the polymer substrate 1 can be placed into contact with a current collector 4. The current collector 4 can be a full current collector, a metal mesh welded with one or more tabs (e.g., formed from metal, etc.), and/or a current collector tab (e.g., a strip, etc.) placed in contact with the electrode layer 3.

The current collector 4 can be formed from a conductive material that serves as an electrical connection between the electrode 10 and an external electrical connection. In some embodiments, the current collector 4 can be, for example, carbon (e.g., a conductive carbon, carbon felt, etc.), nickel, steel, nickel-coated steel, nickel plated copper, tin-coated steel, copper plated nickel, copper plated nickel, nickel plated copper, silver coated copper, copper, magnesium, aluminum, tin, iron, or a material with half nickel and half copper, or similar material. The cathode current collector may be formed into an expanded mesh, perforated metal, foam, foil, perforated foil, wire screen, or a wrapped assembly. In some embodiments, the current collector can be formed into or form a part of a pocket assembly. The current collector 4 can also be in the form of a tab or strip of the current collector material used by itself of in combination with another current collector material. The tab can provide an electrical connection between an external source and the current collector.

The polymer substrate can be applied in single layer or in multiple layers. As shown in FIG. 2A, two layers of the electrode material 2 forming sheets can be in contact with (e.g., coated onto, pressed onto, etc.) the polymer substrate 1, forming the electrode 10 having a sandwiched structure with the polymer substrate 1 in the middle. In some embodiments, two of the electrode layers 3 can be pressed together with one or more current collector tabs 4 in between. The current collector tabs 4 may represent strips of material and may not contact the entirety of the electrode layers 3 material as shown in FIG. 2B. While two current collector tabs 4 are shown in FIG. 2B, only one current collector tab, or more than two current collector tabs 4 can also be used to form the overall electrode.

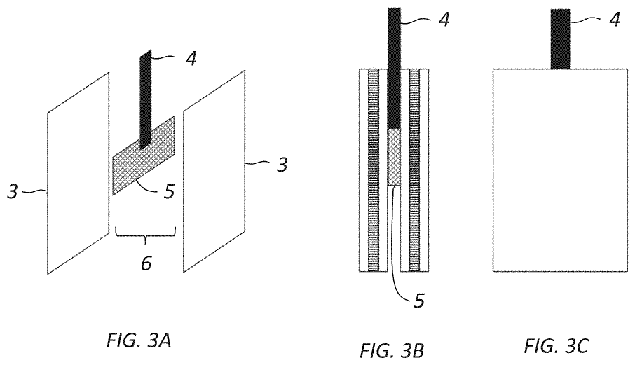

As shown in FIGS. 3A-3C, one or more electrode layers 3 can be coupled to a current collector 6 comprising a tab 4 coupled to a current collector material 5. As shown, two electrode layers 3 can be pressed together with a current collector material 5 (e.g., a mesh strip) that can be electrically coupled (e.g., welded, bonded, etc.) to a tab 4. While two electrode layers 3 can be used, only one electrode layer 3 or more than two electrode layers 3 can also be used to form the overall electrode 10.

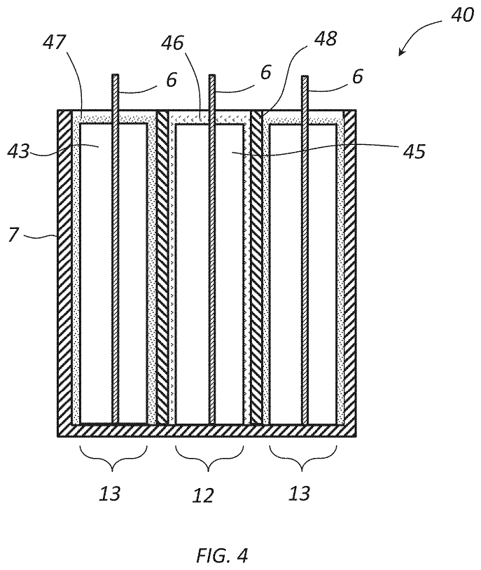

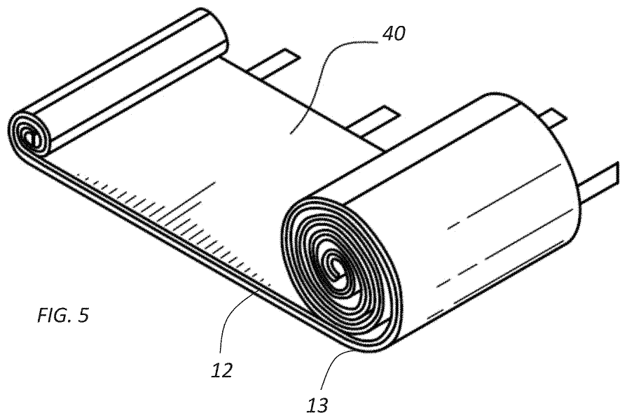

The electrodes having the polymer substrate disposed therein can be applied in various anodes and cathodes used within a battery. Referring to FIG. 4, a battery 40 can have a housing 7, a cathode 12, which can include a current collector 6 and a cathode material 45, and an anode 13. In some embodiments, the anode 13 can comprise a current collector 6, and an anode material 43. It is noted that the scale of the components in FIG. 1 may not be exact as the features are illustrates to clearly show the electrolyte around the anode 13 and the cathode 12. FIG. 1 shows a prismatic battery arrangement having a plurality of anodes 13 and cathode 12. In other embodiments, the battery can be a cylindrical battery (e.g., as shown in FIG. 5) having the electrodes arranged concentrically or in a rolled configuration in which the anode and cathode are layered and then rolled to form a jelly roll configuration. The current collector 6 and cathode material 45 are collectively called either the cathode 12 or the positive electrode 12. Similarly, the anode material 45 with the optional current collector 6 can be collectively called either the anode 13 or the negative electrode 13.

In some embodiments, the battery 40 can comprise one or more cathodes 12 and one or more anodes 13. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jelly roll configuration, the battery 40 may only have one cathode 12 and one anode 13 in a rolled configuration such that a cross section of the battery 40 includes a layered configuration of alternating electrodes.

In an embodiment, housing 7 comprises a molded box or container that is generally non-reactive with respect to the electrolyte solution(s) in the battery 40. In an embodiment, the housing 7 comprises a polypropylene molded box, an acrylic polymer molded box, or the like.

The cathode 12 can comprise one or more electrode layers having a polymer substrate as described herein. Any of the polymer substrates as described with respect to FIGS. 1-3 can be used with the cathode 12 in addition to the cathode material 45. The cathode 12 can comprise a mixture of components including an electrochemically active material, a binder, a conductive material, and/or one or more additional components that can serve to improve the lifespan, rechargeability, and electrochemical properties of the cathode 12. The cathode can comprise an active cathode material 45 (e.g., an electroactive material). Suitable cathode materials 45 can include, but are not limited to, manganese dioxide, copper manganese oxide, hausmannite, manganese oxide, copper intercalated bismuth birnessite, birnessite, todokorite, ramsdellite, pyrolusite, pyrochroite, lead, lead hydroxide, lead oxide, nickel oxyhydroxide, silver oxide, an air electrode, conductive polymers, intercalating materials, or any combination thereof. The electroactive component in the cathode material 45 can be between 1 and 99 wt. % of the weight of the cathode material 45, and the conductive additive can be between 1 and 99 wt. %.

In some embodiments, the active cathode material can based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, birnessite, ramsdellite, hollandite, romanechite, todorkite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄), CuMn₂O₄, zinc manganese dioxide. In general the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive to the cathode material 45 such as conductive carbon enables high loadings of an electroactive material in the cathode material, resulting in high volumetric and gravimetric energy density. The conductive additive can be present in a concentration between about 1-30 wt. %. In some embodiments, the conductive additive can comprise graphite, carbon fiber, carbon black, acetylene black, single walled carbon nanotubes, multi-walled carbon nanotubes, nickel or copper coated carbon nanotubes, dispersions of single walled carbon nanotubes, dispersions of multi-walled carbon nanotubes, graphene, graphyne, graphene oxide, or a combination thereof. Higher loadings of the electroactive material in the cathode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), Zenyatta graphite, and combinations thereof. When the electroactive material comprises manganese, the birnessite discharge reaction comprises a dissolution-precipitation reaction where Mn' ions become soluble and precipitate out on the conductive carbon as Mn²⁺. This second electron process can involve the formation of a non-conductive manganese hydroxide [Mn(OH)₂] layer on the conductive graphite.

In some embodiments, the conductive additive can have a particle size range from about 1 to about 50 microns, or between about 2 and about 30 microns, or between about 5 and about 15 microns. In an embodiment, the conductive additive can include expanded graphite having a particle size range from about 10 to about 50 microns, or from about 20 to about 30 microns. In some embodiments, the mass ratio of graphite to the conductive additive can range from about 5:1 to about 50:1, or from about 7:1 to about 28:1. The total carbon mass percentage in the cathode paste can range from about 5% to about 99% or between about 10% to about 80%. In some embodiments, the electroactive component in the cathode material 2 can be between 1 and 99 wt. % of the weight of the cathode material 45, and the conductive additive can be between 1 and 99 wt. %.

The cathode material 45 can also comprise a conductive component. The addition of a conductive component such as metal additives to the cathode material may be accomplished by the addition of one or more metal powders such as nickel powder to the cathode mixture. The conductive metal component can be present in a concentration of between about 0-30 wt %. The conductive metal component may be, for example, nickel, copper, silver, gold, tin, cobalt, antimony, brass, bronze, aluminum, calcium, iron, or platinum. In one embodiment, the conductive metal component is a powder. In some embodiments, the conductive component can be added as an oxide and/or salt. For example, the conductive component can be cobalt oxide, cobalt hydroxide, lead oxide, lead hydroxide, or a combination thereof. In some embodiments, a second conductive metal component can be added to act as a supportive conductive backbone for the first and second electron reactions to take place. The second electron reaction has a dissolution-precipitation reaction where Mn²⁺ ions become soluble in the electrolyte and precipitate out on the graphite resulting in an electrochemical reaction and the formation of manganese hydroxide [Mn(OH)₂] which is non-conductive. This ultimately results in a capacity fade in subsequent cycles. Suitable second component include transition metals like Ni, Co, Fe, Ti and metals like Ag, Au, Al, Ca. Oxides and salts of such metals are also suitable. Transition metals like Co can also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% second conductive metal component, and 1-10% binder.

In some embodiments, a binder can be used with the cathode material 45. The binder can be present in a concentration of between about 0-10 wt. %. In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % carboxymethyl cellulose (CMC) solution cross-linked with 0-10 wt. % polyvinyl alcohol (PVA) on an equal volume basis. The binder, compared to the traditionally-used TEFLON®, shows superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon were used to create rollable binders. Using the aqueous-based binder helps in achieving a significant fraction of the two electron capacity with minimal capacity loss over many cycles. In some embodiments, the binder can be water-based, have superior water retention capabilities, adhesion properties, and help to maintain the conductivity relative to an identical cathode using a TEFLON® binder instead. Examples of hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. In some embodiments, a 0-10 wt. % solution of water-cased cellulose hydrogen can be cross linked with a 0-10 wt. % solution of crosslinking polymers by, for example, repeated freeze/thaw cycles, radiation treatment or chemical agents (e.g. epichlorohydrin). The aqueous binder may be mixed with 0-5% TEFLON® to improve manufacturability.

The cathode material 45 can also comprise additional elements. The additional elements can be included in the cathode material 45 including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). The bismuth compound can be present in the cathode material at a concentration between about 1-20 wt % of the weight of the cathode material 45. Examples of inorganic bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth, or any combination thereof.

The copper compound can be incorporated into the cathode material 45 as an organic or inorganic salt of copper (oxidation states 1, 2, 3, or 4), as a copper oxide, or as copper metal (i.e., elemental copper). The copper compound can be present in a concentration between about 1-70 wt. % of the weight of the cathode material 45. In some embodiments, the copper compound is present in an amount of between about 5-50 wt. % of the weight of the cathode material 45. In other embodiments, the copper compound is present in a concentration between about 10-50 wt. % of the weight of the cathode material 45. In yet other embodiments, the copper compound is present in a concentration between about 5-20 wt. % of the weight of the cathode material 45. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which cannot withstand galvanostatic cycling as well.

The cathode material 45 can be formed on a current collector, including any of the current collectors described herein with respect to FIGS. 2 and 3.

The anode 13 can comprise one or more electrode layers having a polymer substrate as described herein. Any of the polymer substrates as described with respect to FIGS. 1-3 can be used with the anode 13 in addition to the anode material 43. In some embodiments, the electroactive component of the anode material 43 can comprise lithium, sodium, magnesium, aluminum, zinc, lead, iron, or any combination thereof. In some embodiments, the anode material 43 can comprise zinc, which can be present as elemental zinc and/or zine oxide. In some embodiments, the Zn anode mixture comprises Zn, zinc oxide (ZnO), an electronically conductive material, and a binder. The Zn may be present in the anode material 43 in an amount of from about 50 wt. % to about 90 wt. %, alternatively from about 60 wt. % to about 80 wt. %, or alternatively from about 65 wt. % to about 75 wt. %, based on the total weight of the anode material. Additional elements that can be in the anode in addition to the zinc or in place of the zinc include, but are not limited to, lithium, aluminum, magnesium, iron, cadmium, and a combination thereof, where each element can be present in amounts that are the same or similar to that of the zinc described herein.

In some embodiments, the anode material 43 can comprise zinc oxide (ZnO), which may be present in an amount of from about 5 wt. % to about 20 wt. %, alternatively from about 5 wt. % to about 15 wt. %, or alternatively from about 5 wt. % to about 10 wt. %, based on the total weight of anode material 43. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In an embodiment, an electrically conductive material may be optionally present in the anode material in an amount of from about 5 wt. % to about 20 wt. %, alternatively from about 5 wt. % to about 15 wt. %, or alternatively from about 5 wt. % to about 10 wt. %, based on the total weight of the anode material. As will be appreciated by one of skill in the art, and with the help of this disclosure, the electrically conductive material can be used in the Zn anode mixture as a conducting agent, e.g., to enhance the overall electric conductivity of the Zn anode mixture. Non-limiting examples of electrically conductive material suitable for use can include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof.

The anode material 43 may also comprise an optional binder. Generally, a binder functions to hold the electroactive material particles (e.g., Zn used in anode, etc.) together and in contact with the current collector. The binder can be present in a concentration of 0-10 wt %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride, and polypyrrole. The binder may also be a cellulose film sold as cellophane. The binder may also be TEFLON®, which is a very resistive material, but its use in the industry has been widespread due to its good rollable properties. In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material 43.

The electrolyte can serve as an ion transporter such as an aqueous electrolyte, an aqueous gelled electrolyte, or anon-aqueous electrolyte. In some embodiments, the electrolyte can comprises any suitable aqueous electrolyte comprising ionic conductivity and with a pH value between 0 and 15. In an embodiment, the electrolyte can have a pH value above 14, alternatively less than about 14, alternatively less than about 13, or alternatively less than about 12. In the case of rechargeable batteries, the electrolyte is important both for the active/discharging cycle of the battery (while the battery supplies a current) and for the recharging cycle when Zn may be electrodeposited to replenish the anode material.

In an embodiment, the electrolyte comprises a hydroxide such as potassium hydroxide, sodium hydroxide, lithium hydroxide, cesium hydroxide, or any combination thereof, in a concentration of from about 1 wt. % to about 50 wt. %, alternatively from about 10 wt. % to about 40 wt. %, or alternatively from about 25 wt. % to about 35 wt. %, based on the total weight of the electrolyte solution. In an embodiment, the electrolyte comprises potassium hydroxide in a concentration of about 30 wt. %, based on the total weight of the electrolyte within the cell. When a non-aqueous electrolyte is used, the nonaqueous electrolytes can include, but are not limited to, organic electrolyte, ionic liquid and polymer solid electrolyte.

In some embodiments, one or more gelled aqueous electrolytes can be used. The use of a gelled electrolyte may allow for different electrolyte compositions in contact with the anode 13 and the cathode 12. For example, an electrolyte in contact with the anode can have a pH between about 7 and about 14, and the electrolyte in contact with the cathode can have a pH ranging from neutral to acidic. The separator 48 can prevent mixing of the electrolytes when different compositions are used. In some embodiments, the gelling or polymerization of the electrolyte can prevent the mixing of the electrolytes, and as a result, the separator 48 may be optional in some embodiments.

In some embodiments, a separator 48 can be disposed between each anode 13 and cathode 12 when the electrodes are constructed into the battery. Depending on the type of electrolyte used, the separator 48 can be optional in some embodiments. The separator 48 may comprise one or more layers. Suitable layers can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 48 can comprise a CELGARD® brand microporous separator. In an embodiment, the separator 48 can comprise a FS 2192 SG membrane, which is a polyolefin nonwoven membrane commercially available from Freudenberg, Germany. In some embodiments, the separator 48 can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, nylon, polyester, polyethylene, polypropylene, poly(tetrafluoroethylene) (PTFE), poly(vinyl chloride) (PVC), polyvinyl alcohol, cellulose or any combinations thereof.

When constructed into a battery, the battery can be used as a primary or secondary battery. When used as a secondary battery, the battery can be charged and discharged (e.g., cycled between charging and discharging) any number of times.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

An alkaline Zn/MnO₂ prismatic cell was fabricated. The cell configuration was 2″ by 3″ with one cathode and two anodes. The anode was fabricated from a paste of metallic zinc powders and binder material. A copper mesh was used as the current collector. A polypropylene mesh was applied in the cathode. The cathode material was mainly electrolytic MnO₂ (EMD) with conductive carbon and binders. Two EMD sheets were first coated onto a layer of polypropylene (PP) mesh as shown in FIG. 1. Then two EMD/PP mesh electrodes were pressed together with 2 Ni tabs (0.25″ wide) to achieve one cathode (FIG. 2). 30 wt. % KOH was used as the electrolyte.

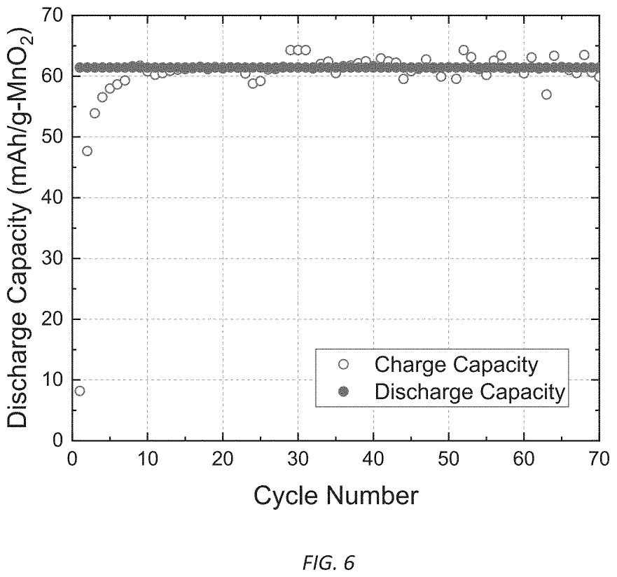

The cell was cycled at a rate of C/50 (C equals the 1^{st} electron capacity of MnO₂). The depth of discharge (DOD) was around 20% of MnO₂ (1^{st} electron capacity) and 5% of Zn. The cell was able to cycle stably, achieving the desired capacity above 1.0V for more than 70 cycles (FIG. 6).

### Example 2

An alkaline Zn/MnO₂ prismatic cell was fabricated. Similarly, the anode was fabricated from a paste of metallic zinc powders and binder material. A copper mesh was used as the current collector. A polypropylene mesh was applied in the cathode. The cathode material was mainly electrolytic MnO₂ (EMD) with conductive carbon and binders. Two EMD sheets were first coated onto a layer of polypropylene (PP) mesh as shown in FIG. 1. Then two EMD/PP mesh electrodes were pressed together with 1 Ni tab welded to a 0.25″ by 2″ Ni mesh strip to achieve one cathode (FIG. 3). The EMD/PP mesh cathode was tested in 2″ by 3″ prismatic cell configuration. One cathode was paired with two anodes. 30 wt. % KOH was used as the electrolyte.

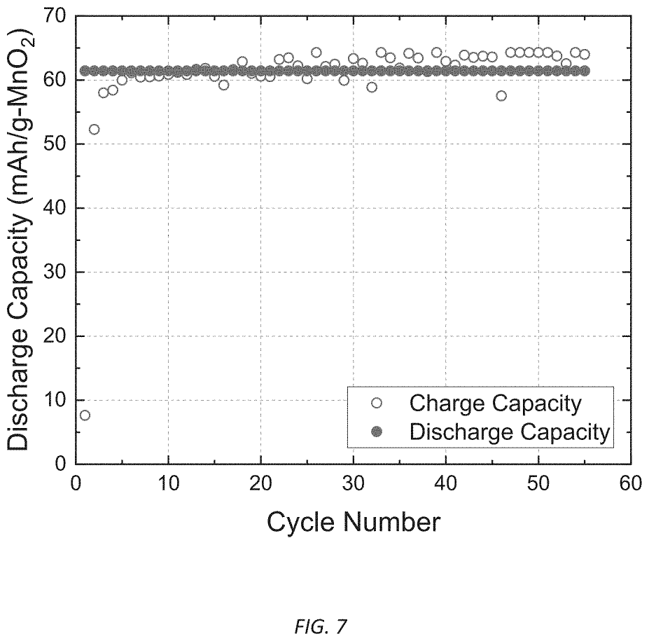

The cell was cycled at a rate of C/50 (C equals the 1^{st} electron capacity of MnO₂). The depth of discharge (DOD) was around 20% of MnO2 (1^{st} electron capacity) and 5% of Zn. The cell was able to cycle stably, achieving the desired capacity above 1.0V for more than 50 cycles (FIG. 7).

### Example 3

An alkaline Zn/MnO₂ cylindrical cell was fabricated. The anode was fabricated from a paste of metallic zinc powders and binder material. A polypropylene mesh was used as the substrate for anode roll to roll coating. The dimension of an anode piece was 80″ by 6″. Eight (8) copper tabs were inserted as the anode current collector. A nickel mesh was applied in the cathode. The cathode material was mainly electrolytic MnO₂ (EMD) with conductive carbon and binders. Each cathode piece was 75″ by 6″ in dimension. Nickel tabs were welded to the nickel mesh as shown in FIG. 5. A cylindrical cell was fabricated by making a jelly roll from one anode and one cathode as shown in FIG. 5. The electrolyte comprised 25 wt. % KOH.

Having described various systems and methods herein, certain embodiments can include, but are not limited to:

In a first embodiment, a battery comprises: an anode; a cathode; a separator disposed between the anode and the cathode; and an electrolyte in fluid communication with the anode, the cathode, and the separator, wherein at least one of the anode or the cathode comprises an electroactive material disposed on a polymer substrate.

A second embodiment can include the battery of the first embodiment, wherein the battery is a primary battery or a secondary battery.

A third embodiment can include the battery of the first or second embodiment, wherein the battery is prismatic or cylindrical.

A fourth embodiment can include the battery of any one of the first to third embodiments, wherein the anode comprises lithium, sodium, magnesium, aluminum, zinc, lead, or iron.

A fifth embodiment can include the battery of any one of the first to fourth embodiments, wherein the cathode comprises lead oxide, manganese oxide, nickel oxyhydroxide, silver oxide, an air electrode, conductive polymers, or intercalating materials.

A sixth embodiment can include the battery of any one of the first to fifth embodiments, wherein the separator comprises nylon, polyester, polyethylene, polypropylene, poly(tetrafluoroethylene) (PTFE), poly(vinyl chloride) (PVC), polyvinyl alcohol, cellulose, or any combinations thereof.

A seventh embodiment can include the battery of any one of the first to sixth embodiments, wherein the electrolyte is an aqueous electrolyte or a nonaqueous electrolyte.

An eighth embodiment can include the battery of any one of the first to seventh embodiments, wherein the electrolyte is an aqueous electrolyte, and wherein the aqueous electrolyte is alkaline electrolyte, neutral electrolyte, acidic electrolyte, aqueous gelled electrolyte, or any combinations thereof.

A ninth embodiment can include the battery of any one of the first to eighth embodiments, wherein the electrolyte is a nonaqueous electrolyte, and wherein the nonaqueous electrolyte is organic electrolyte, ionic liquid, polymer solid electrolyte, or any combinations thereof.

In a tenth embodiment, an electrode layer comprises: an electrode material, wherein the electrode material comprises an electroactive material, and wherein the electrode material forms an electrode material sheet; a polymer substrate, wherein the electrode material sheet is disposed on the polymer substrate; and a current collector in electrical contact with the electrode material.

An eleventh embodiment can include the electrode of the tenth embodiment, wherein the electrode material sheet is a porous sheet.

A twelfth embodiment can include the electrode of the tenth or eleventh embodiment, wherein the polymer substrate is a porous sheet in the form of an expanded mesh, a woven mesh, a foam, a perforated foil, a pierced foil, a wire screen, or any combinations thereof.

A thirteenth embodiment can include the electrode of any one of the tenth to twelfth embodiments, wherein the polymer substrate is a nonporous sheet in the form of a foil, a sheet, or any combinations thereof.

A fourteenth embodiment can include the electrode of any one of the tenth to thirteenth embodiments, wherein the polymer substrate comprises polyamides, polycarbonate, polyester, polyethylene, polypropylene, polystyrene, polyvinyl chloride, acrylonitrile butadiene styrene, polytetrafluoroethylene, polyimide, polysulfone, polyetheretherketone, polyaniline, polypyrrole, poly(3,4-ethylenedioxythiophene), or any combinations thereof.

A fifteenth embodiment can include the electrode of any one of the tenth to fourteenth embodiments, wherein the current collector is constructed into a mesh, a foam, a sheet, a perforated sheet, or any combinations thereof.

A sixteenth embodiment can include the electrode of any one of the tenth to fifteenth embodiments, wherein a thickness of the polymer substrate is 10 μm to 5 mm.

A seventeenth embodiment can include the electrode of any one of the tenth to sixteenth embodiments, wherein a porosity of the polymer substrate is 0 to 90%.

An eighteenth embodiment can include the electrode of any one of the tenth to seventeenth embodiments, wherein a pore size of the polymer substrate is 0 to 1 cm.

A nineteenth embodiment can include the electrode of any one of the tenth to eighteenth embodiments, wherein the polymer substrate comprises a conductive coating.

A twentieth embodiment can include the electrode of the nineteenth embodiment, wherein the conductive coating comprises bismuth, indium, calcium, barium, magnesium, silver, lead, cadmium, tin, titanium, iron, aluminum, nickel, copper, gold, platinum or any combinations thereof.

A twenty first embodiment can include the electrode of the nineteenth or twentieth embodiment, wherein the conductive coating is applied by electrodeposition, electroless plating, thermal spraying, or any combinations thereof.

A twenty second embodiment can include the electrode of any one of the tenth to twenty first embodiments, wherein the current collector comprises nickel, steel, copper, magnesium, aluminum, tin, iron, platinum, silver, gold, titanium, nickel-coated steel, nickel coated copper, copper coated nickel, copper coated steel, tin coated steel, silver coated copper, conductive carbon or any combinations thereof.

A twenty third embodiment can include the electrode of any one of the tenth to twenty second embodiments, wherein the current collector is constructed into a tab, an expanded mesh, a woven mesh, a perforated sheet, a foam, a foil, a perforated foil, a wire screen, a wrapped assembly, or any combinations thereof.

A twenty fourth embodiment can include the electrode of any one of the tenth to twenty third embodiments, further comprising: a second electrode material sheet formed from the electrode material, wherein the electrode sheet is disposed on a first side of the polymer substrate and the second electrode material sheet is disposed on a second side of the polymer substrate, wherein the first side is opposite the second side.

A twenty fifth embodiment can include the electrode of any one of the tenth to twenty fourth embodiments, wherein the polymer substrate comprises a plurality of layers.

A twenty sixth embodiment can include the electrode of any one of the tenth to twenty fifth embodiments, wherein the electrode material is integrated into the polymer substrate by coating, printing, pressing, welding, thermal spraying or any combinations thereof.

In a twenty seventh embodiment, a method of operating a battery comprises: discharging a battery, wherein the battery comprises: a housing; an anode; a cathode; a separator disposed between the anode and the cathode within the housing; and an electrolyte in fluid communication with the anode, the cathode, and the separator, wherein at least one of the anode or the cathode comprises an electroactive material disposed on a polymer substrate.

A twenty eighth embodiment can include the method of the twenty seventh embodiment, further comprising: recharging the battery.

A twenty ninth embodiment can include the method of the twenty seventh or twenty eighth embodiment, wherein the anode comprises lithium, sodium, magnesium, aluminum, zinc, lead, or iron.

A thirtieth embodiment can include the method of any one of the twenty seventh to twenty ninth embodiments, wherein the cathode comprises lead oxide, manganese oxide, nickel oxyhydroxide, silver oxide, an air electrode, conductive polymers, or intercalating materials.

A thirty first embodiment can include the method of any one of the twenty seventh to thirtieth embodiments, wherein the separator comprises nylon, polyester, polyethylene, polypropylene, poly(tetrafluoroethylene) (PTFE), poly(vinyl chloride) (PVC), polyvinyl alcohol, cellulose, or any combinations thereof.

A thirty second embodiment can include the method of any one of the twenty seventh to thirty first embodiments, wherein the electrolyte is an aqueous electrolyte or a nonaqueous electrolyte.

A thirty third embodiment can include the method of any one of the twenty seventh to thirty second embodiments, wherein the electrolyte is an aqueous electrolyte, and wherein the aqueous electrolyte is alkaline electrolyte, neutral electrolyte, acidic electrolyte, aqueous gelled electrolyte, or any combinations thereof.

A thirty fourth embodiment can include the method of any one of the twenty seventh to thirty third embodiments, wherein the electrolyte is a nonaqueous electrolyte, and wherein the nonaqueous electrolyte is organic electrolyte, ionic liquid, polymer solid electrolyte, or any combinations thereof.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

What is claimed is:

1. A battery comprising:
an anode;
a cathode;
a separator disposed between the anode and the cathode; and
an electrolyte, wherein at least one of the anode or the cathode comprises an electroactive material disposed on a polymer substrate.

2. The battery of claim 1, wherein the battery is a primary battery or a secondary battery.

3. The battery of claim 1, wherein the battery is prismatic or cylindrical.

4. The battery of claim 1, wherein the anode comprises lithium, sodium, magnesium, aluminum, zinc, lead, or iron.

5. The battery of claim 1, wherein the cathode comprises lead oxide, manganese oxide, nickel oxyhydroxide, silver oxide, an air electrode, conductive polymers, or intercalating materials.

6. The battery of claim 1, wherein the separator comprises nylon, polyester, polyethylene, polypropylene, poly(tetrafluoroethylene) (PTFE), poly(vinyl chloride) (PVC), polyvinyl alcohol, cellulose, or any combinations thereof.

7. The battery of claim 1, wherein the electrolyte is an aqueous electrolyte or a nonaqueous electrolyte.

8. The battery of claim 1, wherein the electrolyte is an aqueous electrolyte, and wherein the aqueous electrolyte is alkaline electrolyte, neutral electrolyte, acidic electrolyte, aqueous gelled electrolyte, or any combinations thereof.

9. The battery of claim 1, wherein the electrolyte is a nonaqueous electrolyte, and wherein the nonaqueous electrolyte is organic electrolyte, ionic liquid, polymer solid electrolyte, or any combinations thereof.

10. An electrode comprising:
an electrode material, wherein the electrode material comprises an electroactive material, and wherein the electrode material forms an electrode material sheet;
a polymer substrate, wherein the electrode material sheet is disposed on the polymer substrate; and
a current collector in electrical contact with the electrode material.

11. The electrode of claim 10, wherein the electrode material sheet is a porous sheet.

12. The electrode of claim 10, wherein the polymer substrate is a porous sheet in the form of an expanded mesh, a woven mesh, a foam, a perforated foil, a pierced foil, a wire screen or any combinations thereof.

13. The electrode of claim 10, wherein the polymer substrate is a nonporous sheet in the form of a foil, a sheet or any combinations thereof.

14. The electrode of claim 10, wherein the polymer substrate comprises polyamides, polycarbonate, polyester, polyethylene, polypropylene, polystyrene, polyvinyl chloride, acrylonitrile butadiene styrene, polytetrafluoroethylene, polyimide, polysulfone, polyetheretherketone, polyaniline, polypyrrole, poly(3,4-ethylenedioxythiophene) or any combinations thereof.

15. The electrode of claim 10, wherein the current collector is constructed into a mesh, a foam, a sheet, a perforated sheet, or any combinations thereof.

16. The electrode of claim 10, wherein a thickness of the polymer substrate is 10 μm to 5 mm.

17. The electrode of claim 10, wherein a porosity of the polymer substrate is 0 to 90%.

18. The electrode of claim 10, wherein a pore size of the polymer substrate is 0 to 1 cm.

19. The electrode of claim 10, wherein the polymer substrate comprises a conductive coating.

20. The polymer substrate of claim 19, wherein the conductive coating comprises bismuth, indium, calcium, barium, magnesium, silver, lead, cadmium, tin, titanium, iron, aluminum, nickel, copper, gold, platinum or any combinations thereof.

21. The polymer substrate of claim 19, wherein the conductive coating is applied by electrodeposition, electroless plating, thermal spraying, or any combinations thereof.

22. The electrode of claim 10, wherein the current collector comprises nickel, steel, copper, magnesium, aluminum, tin, iron, platinum, silver, gold, titanium, nickel-coated steel, nickel coated copper, copper coated nickel, copper coated steel, tin coated steel, silver coated copper, conductive carbon or any combinations thereof.

23. The electrode of claim 10, wherein the current collector is constructed into a tab, an expanded mesh, a woven mesh, a perforated sheet, a foam, a foil, a perforated foil, a wire screen, a wrapped assembly, or any combinations thereof.

24. The electrode of claim 10, further comprising: a second electrode material sheet formed from the electrode material, wherein the electrode sheet is disposed on a first side of the polymer substrate and the second electrode material sheet is disposed on a second side of the polymer substrate, wherein the first side is opposite the second side.

25. The electrode of claim 10, wherein the polymer substrate comprises a plurality of layers.

26. The electrode of claim 10, wherein the electrode material is integrated into the polymer substrate by coating, printing, pressing, welding, thermal spraying or any combinations thereof.

27. A method of operating a battery, the method comprising:
discharging a battery, wherein the battery comprises:
a housing;
an anode;
a cathode;
a separator disposed between the anode and the cathode within the housing; and
an electrolyte in fluid communication with the anode, the cathode, and the separator, wherein at least one of the anode or the cathode comprises an electroactive material disposed on a polymer substrate.

28. The method of claim 27, further comprising:
recharging the battery.

29. The method of claim 27, wherein the anode comprises lithium, sodium, magnesium, aluminum, zinc, lead, or iron.

30. The method of claim 27, wherein the cathode comprises lead oxide, manganese oxide, nickel oxyhydroxide, silver oxide, an air electrode, conductive polymers, or intercalating materials.

31. The method of claim 27, wherein the separator comprises nylon, polyester, polyethylene, polypropylene, poly(tetrafluoroethylene) (PTFE), poly(vinyl chloride) (PVC), polyvinyl alcohol, cellulose, or any combinations thereof.

32. The method of claim 27, wherein the electrolyte is an aqueous electrolyte or a nonaqueous electrolyte.

33. The method of claim 27, wherein the electrolyte is an aqueous electrolyte, and wherein the aqueous electrolyte is alkaline electrolyte, neutral electrolyte, acidic electrolyte, aqueous gelled electrolyte, or any combinations thereof.

34. The method of claim 27, wherein the electrolyte is a nonaqueous electrolyte, and wherein the nonaqueous electrolyte is organic electrolyte, ionic liquid, polymer solid electrolyte, or any combinations thereof.
